(19) United States
(12) Patent Application Publication
(10) Pub. No.: US 2009/0133895 A1
(43) Pub. Date: May 28, 2009

(54) Water-Blocked Cable

(76) Inventor: Robert Allen, Leominister, MA (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 12/234,349

(22) Filed: Sep. 19, 2008

Related U.S. Application Data
(60) Provisional application No. 60/973,670, filed on Sep. 19, 2007.

(51) Int. Cl. H01B 11/02; B23P 19/00

(52) U.S. Cl. 174/27; 29/745

(57) ABSTRACT

A water-blocked cable comprised of a first and second line of defense against water invasion wherein said cable is comprised of materials that can meet both indoor and outdoor use requirements.

### CROSS REFERENCE TO RELATED APPLICATIONS

This application claims the benefit of U.S. Provisional Application No. 60/973,670, filed Sep. 19, 2007, the entire disclosure of which is incorporated herein by reference.

### BACKGROUND OF THE INVENTION

1. Field of the Invention

The present invention generally relates to the field of cables. In particular, to data or “category” cables which are designed to resist moisture invasion.

2. Description of Related Art

Electronic devices, and computers in particular, are starting to become ever more connected. Just 30 years ago, the idea of a computer network where machines talked with each other was simply a dream. Today, people from around the world are connected to computer networks which are both local (such as LANs) and worldwide in scope (such as the Internet).

As computers have become increasingly interconnected, there has arisen a more pronounced need for the cables and connectors used to connect them to be able to transfer more information in the same or a shorter amount of time. While wireless networks have attracted a lot of attention recently, the vast majority of networks, and particularly of high speed networks, still communicate by sending electrical signals across conductors wired between them and therefore, as the networks push to be faster, the cables need to adapt to allow faster communication.

One particularly useful type of cable in the computer networking arena, as well as in other applications, are the so-called “category” cables of which category 6 (or CAT6) is currently one of the standards utilized with category 5 or 5e (CAT5, CAT5e) also being used on a fairly regular basis. In category cable, it is necessary to meet certain performance characteristics set by standards setting organizations (such as the ISO or IEEE) for performance and attenuation cross-talk ratio (ACR). Generally, the higher the number of category cable, the more rigorous the requirements and the faster communication the cable is designed for. These standards are set so that networks utilizing the cable can operate and transfer at particular speeds without suffering from loss of data or other problematic concerns. In many respects, the standard defines the label. A CAT6 cable meets certain performance characteristics and therefore can be called “CAT6.”

The exacting standards required for data speed and electrical characteristics of CAT6 or higher cable relate in many cases to cross-talk in the cable. This includes near-end cross-talk (NEXT) and special categories such as far-end cross-talk (FEXT), and Power Sum NEXT (PSNEXT). Cross-talk is the interference in one channel from an adjacent channel and, in particular, relates to the cross-talk or signal interference between two component cables or wire pairs. Category cables generally utilize four component cables each of which is formed of a twisted pair. Each twisted pair comprises two individual conductors or wires (generally insulated from each other) which are twisted about each other to form a generally double helix shape. Over a length of the component cable, the shape of the twisted pair approaches a generally cylindrical shape.

Each of these component cables, and any other components included in the cable, are then encased in a jacket which forms the resultant cable. Cross-talk occurs when electrical impulses from one component cable (wire pair) can migrate to a different wire pair within this cable. In other words, the component cables “talk” in a manner that is undesirable by sharing signals or allowing signals to finish propagating in a component other than the one in which they began propagating. Cross-talk can serve to corrupt data, as in high-speed networks the loss or addition of electrical signals can cause the network to slow. Cross-talk is a significant concern in trying to build category cable because digital data which is propagated incorrectly can be misunderstood when received and therefore has to be re-sent and/or ignored. The problem is particularly acute in CAT6 cables as in CAT6 cables all four twisted pairs (i.e., internal cables) are utilized for data transmission and, accordingly, there is a higher risk of cross-talk between the four twisted pairs.

In addition to the electrical requirements of category cables, it is also necessary that they meet various safety and usability requirements. Cable is not always placed in ideal environments and, as data networks become more important, the need to have cables which can be used under a variety of conditions and in a variety of environments becomes more important. One specific problem in cable usability is water penetration. Cables used outside, in environments where the air is very humid, or used indoors in wet environments (such as in pool areas, locker rooms and the like) have a high risk of water invasion of the cable.

Water invasion of a cable can have a significant impact on the cable's performance. Water in a cable can present a possible public safety hazard (e.g., causing the cable to short out, resulting in a fire or electric shock hazard) as well as degrading performance (e.g., causing interference with data propagation). It is well known by those skilled in the art that the presence of water in the cable can result in inaccurate transfer of electrical signals along the cable because water is capable of conducting electrical signals.

As the standards for category cable, therefore, grow more and more demanding, the need to keep water from invading the cable becomes more important. This is particularly true in cables such as category cables where there are multiple internal cables carrying information.

The first line of defense against water or other material intrusion into a cable is the exterior cable jacket. This device is an external, generally waterproof, covering for all of the components of the cable structure. This device generally serves as a waterproof coating to keep water and other materials from being able to enter the cable structure and interact with the internal cables. While the jackets of the prior art are usually very effective at maintaining this control initially, they are generally ineffective over time as the material of the external cable jacket degrades as a result of exposure to water and other elements. For example, exposure to sunlight over a period of time can result in a degradation of the material comprising the external jacket as the sun's rays slowly break down the jacket's material structure. Accordingly, sunlight (and particularly UV light) can be a particular problem for outside cable installations, where the jacket is in direct contact with the elements.

Still further, even without breakdown due to light exposure, environmental factors alone can result in damage to the jacket. Landscaping tools such as lawnmowers or trimmers can inadvertently damage a jacket if they come into contact with it. The jacket may also be damaged from contact with humans, animals or insects, or may be damaged in severe weather conditions, such as being hit by hail, encased in ice, or exposed to extreme heat.

Because of the possibility of external jacket breakdown and/or damage to the external jacket, in cables which are designed for use in wet environments, it is often necessary to provide for a second line of defense beyond the exterior cable jacket to protect against potential water intrusion. One example of a second line of defense currently used in cables, particularly fiber optic cables, is the use of a structure that serves to absorb water and, by swelling, to inhibit further water intrusion. These types of systems, however, are generally unsuitable in electrical cables as the absorption and swelling of the swellable material results in a degradation of cable performance. This is because the swelling of this second line of defense generally results in increased cross-talk among the component data cable pairs. Accordingly, the use of swellable material as a second line of defense is generally unsuitable for category and data cable applications.

Another problem with the current methods known and utilized in the art to protect against water invasion of a cable is the inability of such cables to meet both indoor and outdoor building and related codes. For example, cables used indoors have to meet various standardized requirements and performance characteristics while outdoor cables often have more demanding weather resistant requirements. Examples of such indoor requirements are certain performance standards regarding burn characteristics of the cable. Many cables designed particularly for outdoor use, and therefore particularly designed to resist water invasion, are unable to meet these requirements as the materials utilized by these cables to achieve their water resistance do not meet indoor burn specifications. In this situation, the cable is useable outside a building, but it is not useable inside a building as the cable is unable to meet indoor building and related codes. This situation creates logistical difficulties and problems as, in this situation, an indoor cable must be switched to an outdoor cable at a given transition point so that the wiring system is compliant with all relevant building and performance codes. This results in additional infrastructure demands on a given wiring system (i.e., both indoor and outdoor cables need to be utilized—a single cable cannot be utilized for both environments) and a possible weak link in the cable chain at the point of transition since a connector has to be used. Further, if there is a wet environment inside a building (such as in a high humidity installation for example), there might not be a cable available that can both adequately resist water infiltration and meet the mandated use and building code requirements.

Accordingly, there is a need in the cable industry for a cable that can meet the necessary electrical and water resistance qualities for proper performance in both interior and exterior applications. Specifically, a cable is needed which can prevent cross-talk and protection against water invasion for a long period of time in both interior and exterior settings.

### SUMMARY OF THE INVENTION

The following is a summary of the invention in order to provide a basic understanding of some of the aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a water-blocked cable including a generally gelatinous petroleum-based filer which can meet internal flame and fire requirements.

There is also described herein a cable comprising: an outer jacket; at least two internal cables located inside such outer jacket; and a petroleum-based filler placed internal to such outer jacket and occupying at least a portion of the space between the outer insulative layers and the internal cables.

In an embodiment of the cable, each of the at least two internal cables is a twisted-pair cable, the at least two internal cables comprise four twisted pair cable, and there may be a spline, which may have a cross-shape in cross-section, separating the four twisted pair cables.

In other embodiments of the cable, the outer jacket comprises a generally monolithic surface, may be comprised of a material selected from the group consisting of: plastic and rubber may resist degradation from UV light and/or oil, or may be made from a material selected from the group consisting of polyolefin, oil resistant PVC, and combinations thereof.

In another embodiment of the cable the cable further comprises a conductive layer external to the outer jacket and/or a conductive layer surrounding each of the internal cables.

In another embodiment of the cable the petroleum-based filed is a gel, possibly a thixotropic gel.

There is also described herein, a method of constructing a cable comprising: providing an outer jacket; placing in the outer jacket at least two internal cables; and inserting into the outer jacket a thixotropic petroleum-based gel at sufficient velocity to have the thixotropic petroleum-based gel flow between the internal cables and the outer jacket.

In an embodiment of the method, each of the at least two internal cables is a twisted-pair cable, the at least two internal cables comprise four twisted pair cable and there may be a spline separating the four twisted pair cables which may have a cross-shape in cross-section.

In another embodiment of the method, the outer jacket is made from a material selected from the group consisting of polyolefin, oil resistant PVC, and combinations thereof.

### BRIEF DESCRIPTION OF THE DRAWINGS

FIG. 1 provides a cut-through view of a first embodiment of a water-blocked data cable.

FIG. 2 provides a cut-through view of a second embodiment of a water-blocked data cable.

### DESCRIPTION OF THE PREFERRED EMBODIMENT(S)

The following description illustrates by way of example and not by way of limitation.

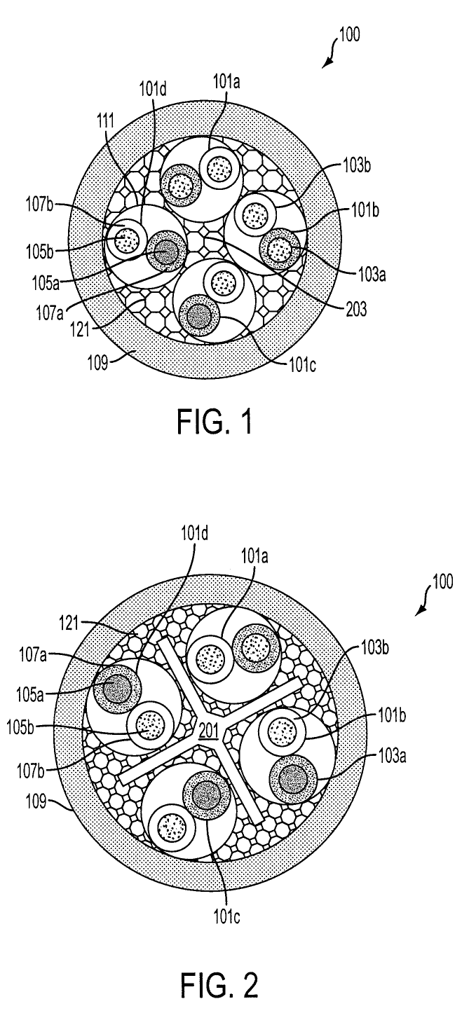

FIGS. 1 and 2 provide for two different embodiments of a water-blocked cable (100) which includes a generally gelatinous petroleum-based filler (121) to provide for water blocking. In the embodiment of FIG. 1, the internal cables (101a), (101b), (101c), and (101d) will be placed in the filler (121) material, which is maintained by the outer jacket (109). In this embodiment, the internal cables (101a), (101b), (101c), and (101d) will be generally twisted pair cables, but any internal cable known to those skilled in the art is contemplated by this application. In the embodiment of FIG. 1, the general position of the internal cables (101a), (101b), (101c) and (101d) relative to each other is generally maintained by a combination of the outer jacket (109) and the internal arrangement of the internal cables (101a), (101b), (101c), and (101d).

In the embodiment of FIG. 2, a spline (201) running the length of the cable (100) is added as a component to the cable structure of FIG. 1. The spline (201) is generally placed in the filler (121). In this position, the spline (201) functions maintain the internal cables (101a), (101b), (101c), and (101d) in a generally fixed position relative to each other. The spline (201) of the embodiment of FIG. 2 is generally formed in the shape of a cross or “X,” however any shaped spline (201) known to those skilled in the art that could function to keep the internal cables (101a), (101b), (101c), and (101d) in a generally fixed and relative position to each other in the cable (100) is contemplated by this application. The inclusion of such splines into cables, as in the cable of FIG. 2, is well known in the prior art as is described in U.S. Pat. Nos. 6,074,503 and 6,596,944, the entire disclosures of which are herein incorporated by reference.

In some embodiments of the cable (100), the insulation on each wire (103) in the twisted pair forming the internal cables (101a), (101b), (101c), and (101d) will generally be sufficient to prevent cross-talk between the internal cables (101a), (101b), (101c), and (101d). For example, in one embodiment of the cable (100) the lay of the various twisted pairs of internal cables (101a), (101b), (101c), and (101d) can be provided so as to generally reduce cross talk without having to resort to a cable separator or spline (201). An example of such adjustment of lay length is contemplated in U.S. Pat. No. 5,424,491, the entire disclosure of which is herein incorporated by reference. One embodiment of a cable (100) which does not utilize a spline (201) or separator to prevent cross-talk, but rather utilizes the lay of the various internal cables (101a), (101b), (101c) and (101d) to prevent cross-talk is shown in FIG. 1.

The CAT6 standards known and utilized by those skilled in the art are generally too rigorous, however, for this use of lay of the various internal cables alone to prevent cross-talk. Accordingly, in these types of cables it is often desirable to further insulate the twisted pairs (101a), (101b), (101c), and (101d) from each other. For this reason, twisted pair data cables (i.e., category cables) often include “X”, “+”, or other generally cross-shaped splines; round splines; and/or elongated splines which are placed within the outer jacket (109) to separate the twisted pairs (101a), (101b), (101c), and (101d).

Both the designs of FIGS. 1 and 2 generally have the same rough layout. There are four twisted-pairs (101a), (101b), (101c), and (101d) included in the cable (100) which are arranged in a generally similar pattern. The four-twisted pairs (101a), (101b), (101c), and (101d) are preferably arranged so that lines drawn between the center points of each non-adjacent twisted pair (101a), (101b), (101c), and (101d) (effectively the centers of the cylinders they take up) form a cross, with the lines at generally right angles. While there are four internal cables in this design, it shall be recognized that designs with more or fewer internal cables can also be used.

When a cross-shaped spline (201) is used, each twisted pairs (101a), (101b), (101c), and (101d) is placed in a single “V” or similar structure formed by two-legs of the cross, placing the material of the spline (201) between each twisted pair (101a), (101b), (101c), and (101d). In effect, the two neighboring twisted pairs (101a), (101b), (101c), and (101d) are separated by a leg of the spline (201). The spline (201) material (which is generally insulative) then serves to inhibit cross-talk between the different twisted pairs (101a), (101b), (101c), and (101d). In a circular (cylindrical) or other “non-armed” splines (201), the four twisted pairs (101a), (101b), (101c), and (101d) are placed about a central spline (201) to hold them apart in conjunction with their interaction with the central jacket (109). This provides sufficient elimination of cross-talk without significant increases in material by simply separating the twisted pairs (101a), (101b), (101c), and (101d) a sufficient amount to prevent the cross-talk. Distance between the individual twisted pairs (101a), (101b), (101c), and (101d) created by the spline (201) can also serve to isolate each twisted pair from the other twisted pair (101a), (101b), (101c), and (101d)). An embodiment of a cable (100) including a central spline (201) of generally cross shape is shown in FIG. 2.

Throughout this disclosure, the embodiments of FIGS. 1 and 2 will be discussed simultaneously as the water blocking design of the cable (100) is similar for each of the two embodiments. Accordingly, reference to or discussion of the “cable” (100) throughout this disclosure explicitly contemplates both designs. The inclusion of a spline (201) within the cable (100) does not serve to modify the ultimate construction of the cable (100), other than that the cable (100) will additionally include the spline (201).

In the embodiment of FIGS. 1 and 2 the cable (100) comprises four internal cables (101a), (101b), (101c), and (101d). This is a standard arrangement for data and category cables. Each of the four internal cables (101a), (101b), (101c), and (101d) comprises a twisted pair cable. A twisted pair cable is formed by two conductors (105a) and (105b) which are each separately surrounded by a layer of insulation (107a) and (107b). This disclosure contemplates any conductor or type of layered insulation known and utilized by those skilled in the art to form a twisted pair cable. Each of these insulated conductors (103a) and (103b) in each internal cable (101a), (101b), (101c), and (101d) is twisted about its counterpart to form the twisted pair cable. Over the length of the cable (100), the twisted pairs (101a), (101b), (101c), and (101d) generally take up an area approximating a cylinder which is indicated for reference as item (111), however, this element is shown only for conceptualization and is not a separate component of the cable (100). At any individual point, the twisted pairs (101a), (101b), (101c), and (101d) do not have to be cylindrical, but over distance, the consideration of the twisted pairs (101a), (101b), (101c), and (101d) as cylindrical can be a conceptually useful in understanding the structure of the cable (100).

The cable (100) is generally made up of four twisted pair cables (101a), (101b), (101c), and (101d) arranged together. In some embodiments, it is contemplated that this can also result in the four twisted pair cables (101a), (101b), (101c), and (101d) being twisted about each other within the cable (100) (that is the resultant internal structure is also twisting in a generally quadruple helical fashion). In yet other embodiments, the four twisted pair cables (101a), (101b) (101c), and (101d) may be laid in a generally cross type pattern. This application contemplates an arrangement of twisted pair cables (101a), (101b), (101c), (101d) known to those skilled in the art. In the embodiment of FIG. 1, the space (203) between the twisted pair cables (101a), (101b), (101c), and (101d) will generally not comprise a spline (201), but in the embodiment of FIG. 2, there may be a spline (201) positioned generally between the relative twisted pairs (101a), (101b), (101c), and (101d) to hold their relative positions and keep them generally separated a certain minimum distance from each other.

When the four twisted pairs (101a), (101b), (101c), and (101d) are placed together directly without the use of a spline (201), as in FIG. 1, the combination of the insulative nature of the various conductor jackets (107a) and (107b) and the spacing of the twisted pairs (101a), (101b), (101c), and (101d) from each other is used to inhibit cross talk. In the alternative embodiment of FIG. 2, the spline (201) is used to maintain the distance and inhibit cross talk.

Once the four twisted pairs (101a), (101b), (101c), and (101d) have been arranged as desired (either without, as in FIG. 1, or with a spline, as in FIG. 2) they are then encased in an exterior jacket (109). The exterior jacket (109) serves to maintain the relative position of the internal cables (101a), (101b), (101c), and (101d), serves to constrain their relative movement, and also generally serves as a first layer of defense in protecting them from exterior environmental factors, such as water damage.

As it comprises the exterior surface of the cable (100), the outer jacket (109) provides a first line of defense against liquid invasion. Specifically, the outer jacket (109) will generally be molded without cuts or openings so as to provide a generally monolithic surface. Further, the outer jacket (109) will generally be constructed of materials known to those skilled in the art which resist water transmission such as, but not limited to, plastics or rubbers. Construction of the outer jacket (109) to inhibit water from seeping through the material to the internal components of the cable (100) located internally out of such materials acts generally as a shield.

The outer jacket (109), in the depicted embodiment, therefore needs to be constructed generally to inhibit degradation effects which could lead to cracks, holes or other “weak links” through which water could seep from forming in its surface. So long as the surface is relatively monolithic, and comprised of a material known to those skilled in the art that generally unsuitable for water passage through its structure, the outer jacket (109) will generally act as a first line of defense, making water much less likely to enter the internal area of the cable (100).

In an embodiment, it is generally preferred that the outer jacket (109) be constructed such that it is generally resistant to degradation from exposure to UV light and exposure to moisture. Further, so as to resist degradation which may be caused by contact with the filler material (121), as discussed later, the outer jacket (109), (and the inner insulation layers (107a) and (107b) of the twisted pairs (101a), (101b), (101c), and (101d)) will generally be comprised of a material known to those skilled in the art to be oil resistant. In an embodiment, so as to meet these criteria of water resistance, oil resistance, and resistance to degradation, the outer jacket (109) will be constructed of polyolefin, oil resistant pvc, other oil resistant plastics known to those skilled in the art, or combinations thereof.

While the outer jacket (109) generally provides for a first line of water blocking defense, the cable (100) includes a second water blocking component as well. In the cable (100), the space internal to the outer jacket (109) and external to the twisted pairs (101a), (101b), (101c), and (101d) will be flooded with a filler (121). This application contemplates a filler (121) made of any material known to those skilled in the art which can meet the water penetration and compound flow tests of ANSI/ICEA S-99-689-1997. Although it is preferred that the filler (121) comprise a petroleum-based compound known to those of skill in the art, and more particularly that it comprise a petroleum-based thixotropic Gel, use of this type of compound is not determinative.

Thixotropic gels are generally preferred because they provide certain benefits in construction of the cable (100) as their viscosity generally decreases when they are in motion. This property of thixotropic gels makes fillers (121) comprised of this type of thixotropic gel material easier to place in the resultant cable (100) during cable (100) construction as a high velocity can be induced into the gel during cable (100) construction when the gel is being inserted into the cable (100), and the gel will effectively “thicken” once the cable (100) is constructed and in use.

Generally, in operation, the filler (121) will act to effectively provide a secondary water-shield/barrier. In a first instance, the use of a petroleum-based compound results in a filler (121) that is generally resistant to water penetration and does not absorb the water. As such, the filler (121) is effectively generally impenetrable to water invasion. Further, as a gelatinous or other semi-liquid material, the filler (121) will generally flow to create a relatively solid boundary which does not allow the water to penetrate through the filler (121) and contact the twisted pairs (101a), (IOlb), (101c), and (101d) within it.

It should be recognized that a semi-liquid or gelatinous material known to those skilled in the art is generally preferred, as the viscous properties of such a material allows the filler (121) to slowly flow toward any opening, gap, hole, degradation or other form of imperfection in the outer jacket (109) of the cable (100), thereby serving to generally plug a hole in the outer jacket (109). In other words, this feature of the filler (121) automatically allows the cable to heal or fix any “wounds” that might occur in the outer jacked (109) via its own structure, thereby inhibiting fluid invasion. Alternatively, if the hole is sufficiently small or the filler (121) is sufficiently viscous, the filler (121) will not fill the hole but will simply act as a solid second layer of defense behind the hole in the outer jacket (109) protecting the cable (100) from water invasion.

While the filler (121) has been described as being placed internal to the outer jacket (109), it should be apparent from FIGS. 1 and 2 that the location of the filler (121) relative to the twisted pairs (101a), (101b), (101c), and (101d) is relatively open. In particular, the filler (121) may generally flow into spaces around and between the twisted pairs (101a), (101b), (101c), and (101d) and or spline (201) as shown in the FIGS., or may be constrained to simply be on the outer surface of the twisted pair (101a), (101b), (101c), and (101d) combination or arrangement. In such an embodiment, the filler (121) would only be positioned between the twisted pairs (101a), (101b), (101c), and (101d) and the outer jacket (109). This application contemplates these, or any other position, that would work to prevent fluid invasion in between the twisted pairs (101a), (101b), (101c) and (101d) from outside the outer jacket (109). As such, this application contemplates any placement of the filler (121) within the cable (100) that could serve to prevent water from getting between the twisted pairs (101a), (101b), (101c), and (101d) and the outer jacket (109) thereby serving to prevent water from getting between the twisted pairs (101a), (101b), (101c), and (101d) which could result in damage or degradation of performance.

While the embodiments of the cable (100) described herein may be constructed of virtually any combination of components, it is preferred that the components comprising the cable (100) be made from materials known by those skilled in the art that are generally burn and flame retardant, such that the finally constructed cable is able to meet all burn and fire guidelines for internal use.

In one example of an embodiment of the invention which is comprised of components that meet the indoor use requirements, the cable (100) comprises copper conductors (105) which are surrounded by polyolefin insulation jackets (107); the filler (121) is a petroleum-based thixotropic Gel; the outer jacket (109) comprises a flame retardant polyolefin; a spline (201), if included, may comprise polyolefin or FR polyolefin. All of these components may be zero or low halogenated. Such a cable arrangement has been found to meet UL 70,000 BTU safety burn for indoor use requirements and thus such an embodiment, among others, may be used for interior use in wet environments.

In a still further embodiments of the cable (100), there may be included a conductive layer surrounding the twisted pairs (101a), (101b), (101c), and (101d) internal to the outer jacket (109). This layer would generally function so as to provide for electromagnetic shielding of the cable (100). In a still further embodiment, a conductive layer may be placed outside the outer jacket (109) so as to provide for electromagnetic shielding. This latter embodiment would generally be referred to as an “armored” cable. This application contemplates any conductive layer known to those skilled in the art for use in the “armored” embodiment of the cable (100).

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A cable comprising:
an outer jacket;
at least two internal cables located inside such outer jacket; and
a petroleum-based filler placed internal to such outer jacket and occupying at least a portion of the space between said outer insulative layers and said internal cables;

2. The cable of claim 1 wherein each of said at least two internal cables is a twisted-pair cable.

3. The cable of claim 2 wherein said at least two internal cables comprise four twisted pair cable.

4. The cable of claim 3, further comprising a spline separating said four twisted pair cables.

5. The cable of claim 4, wherein said spline has a cross-shape in cross-section.

6. The cable of claim 1, wherein said outer jacket comprises a generally monolithic surface.

7. The cable of claim 1, wherein said outer jacket is comprised of a material selected from the group consisting of: plastic and rubber.

8. The cable of claim 1, wherein said outer jacket resists degradation from UV light.

9. The cable of claim 8, wherein said outer jacket resists degradation from contact with oil.

10. The cable of claim 9, wherein said outer jacket is made from a material selected from the group consisting of polyolefin, oil resistant PVC, and combinations thereof.

11. The cable of claim 1, wherein said cable further comprises a conductive layer external to said outer jacket.

12. The cable of claim 1, further comprising a conductive layer surrounding each of said internal cables.

13. The cable of claim 1 wherein said petroleum-based filed is a gel.

14. The cable of claim 14 wherein said petroleum-based filler is a thixotropic gel.

15. A method of constructing a cable comprising:
providing an outer jacket;
placing in said outer jacket at least two internal cables; and
inserting into said outer jacket a thixotropic petroleum-based gel at sufficient velocity to have said thixotropic petroleum-based gel flow between said internal cables and said outer jacket.

16. The method of claim 15 wherein each of said at least two internal cables is a twisted-pair cable.

17. The method of claim 16 wherein said at least two internal cables comprise four twisted pair cable.

18. The method of claim 17, further comprising a spline separating said four twisted pair cables

19. The method of claim 18, wherein said spline has a cross-shape in cross-section.

20. The method of claim 15, wherein said outer jacket is made from a material selected from the group consisting of polyolefin, oil resistant PVC, and combinations thereof.
